(19) United States
(12) Patent Application Publication
(10) Pub. No.: US 2004/0234071 A1
(43) Pub. Date: Nov. 25, 2004

(54) Desktop phone station with data synchronization

(76) Inventors: Hyon S. Bae, Burlingame, CA (US); Sang Yong Kim, (US); Hyun Jin Chung, (US)

Correspondence Address: JACOBSON HOLMAN, PLLC, The Jenifer Building, 400 Seventh Street, N.W., Washington, DC, 20004-2201, US

(21) Appl. No.: 10/431,787

(22) Filed: May 8, 2003

(51) Int. Cl. H04M 1/00; H04M 9/00

(52) U.S. Cl. 379/419

(57) ABSTRACT

A desktop phone station for synchronizing desktop phone contact data with portable contact data stored in a portable data loading device. A communications port on the phone station provides a communications interface for the portable data loading device. The desktop phone station is capable of receiving the portable contact data from the portable data loading device through the communications port. A user interface is provided on the exterior of the phone. The user interface includes control buttons, one of which is a data synchronization button. When the data synchronization button is pressed, the portable contact data received through the communications port is synchronized with desktop phone contact data stored in a memory of the desktop phone station.

### FIELD

The present invention generally relates to desktop phones, and more particularly, to a desktop phone which provides for synchronization of contact information with a portable data loading device.

### BACKGROUND

The usage of mobile phones, e.g. cellular phones, is continuously increasing throughout the world. People are relying more and more on their mobile phones as their primary phones at home, work and in between. With the increased use and popularity of mobile phones, many individuals have spent a lot of time customizing their mobile phones to store personalized information on the phones, including names, addresses, phone numbers, pre-defined groups, screen savers, speed dialing and other features and applications offered by phones for customization.

While the usage of mobile phones is increasing, the usage of desktop phones remains. As used herein, “desktop phone” and “desktop phone station” refer to any phone apparatus which is ordinarily connected to a conventional telephone line. These include phones made to sit on a desk or table, and wall-mounted phones. There are a number of reasons supporting the continuing need for reliable desktop phones. In many locations throughout the world, there is minimal or unreliable reception for mobile phones. Further, some desktop phone models offer built-in functions not provided by many mobile phone models such as speaker, teleconference, hold, and call forwarding. Lastly, regardless of the popularity of mobile phones, it is still customary in many work and home environments to use traditional desktop phones.

As mobile phone technology has advanced, so have the technological features of desktop phones. For instance, desktop phones now include memory banks large enough to store numerous phone numbers. However, this feature alone does not benefit the user who has already exerted time and energy to storing names, addresses and phone numbers in the user's mobile phone. The user is not interested in repeating the same data entry exercise, now in the desktop phone instead of the mobile phone. Still, most users desire to have up-to-date information in the desktop phone so they can use the phone with similar convenience as the mobile phone.

While conventional desktop phones offer numerous features such as built-in answering machines, caller ID functions, storage of contact information, and speaker functions, conventional desktop phones do not provide for the importation and synchronization of contact data from external sources. If the user desires to update the contact information in his desktop phone to reflect more current contact information in his mobile phone, the user is forced to spend the time and energy necessary to manually enter the same data in the desktop phone.

### SUMMARY

Aspects of the present invention relate to a desktop phone station for synchronizing desktop phone contact data with portable contact data. The desktop phone contact data is stored in a memory within the desktop phone station, while the portable contact data is stored in a portable data loading device.

The desktop phone includes a casing having an interior region and an exterior region. A handset docking area is formed on the exterior region of the casing. A telephone operations unit is situated in the casing interior region. The telephone operations unit includes a ring module, a dialer module, and a speech module coupled to a telephone line interface mounted to the casing and accessible from the casing exterior region.

A user interface is provided on the exterior region of the casing. The user interface includes a plurality of control buttons. One of the control buttons is a data synchronization button. A display is mounted on the exterior region of the casing. The display is capable of displaying information including the desktop phone contact data.

A communications port provides a communications interface for the portable data loading device. The communications port is capable of receiving the portable contact data from the portable data loading device. A controller is coupled to the memory and the communications interface. Responsive to the data synchronization button being pressed, the controller interacts with the memory and the communications interface to synchronize the portable contact data received from the communications port with the desktop phone contact data stored in the memory.

### BRIEF DESCRIPTION OF THE FIGURES

The detailed description below may be better understood with reference to the following figures. The figures illustratively show one or more embodiments of the invention, and are not intended to limit the scope of the claims in any way. The components in the figures are not necessarily to scale, emphasis instead being placed upon clearly illustrating principles of the present invention. In the figures, like reference numerals designate corresponding parts throughout the several views.

FIGS. 1A and 1B are front views of an exemplary desktop phone station 100 for synchronizing contact data with an external device, constructed according to an embodiment of the present invention;

FIGS. 2A and 2B show perspective views of desktop phone station 100 in use with portable data loading device 105, according to an embodiment of the present invention;

FIG. 3 shows a functional block diagram 300 of desktop phone station 100, constructed according to an embodiment of the present invention;

FIGS. 4A and 4B are perspective views of a portable data loading device, constructed according to one embodiment of the present invention.

FIGS. 5A-5E are front views of an embodiment of the portable data loading device of the present invention in use with a mobile phone.

FIG. 6 is a perspective view of a disassembled embodiment of the portable data loading device of the present invention;

FIG. 7A is a top view of an embodiment of the board of the portable data loading device of the present invention;

FIG. 7B is a side view of an embodiment of the board of the portable data loading device of the present invention; and

FIG. 7C is a bottom view of an embodiment of the board of the portable data loading device of the present invention.

### DETAILED DESCRIPTION

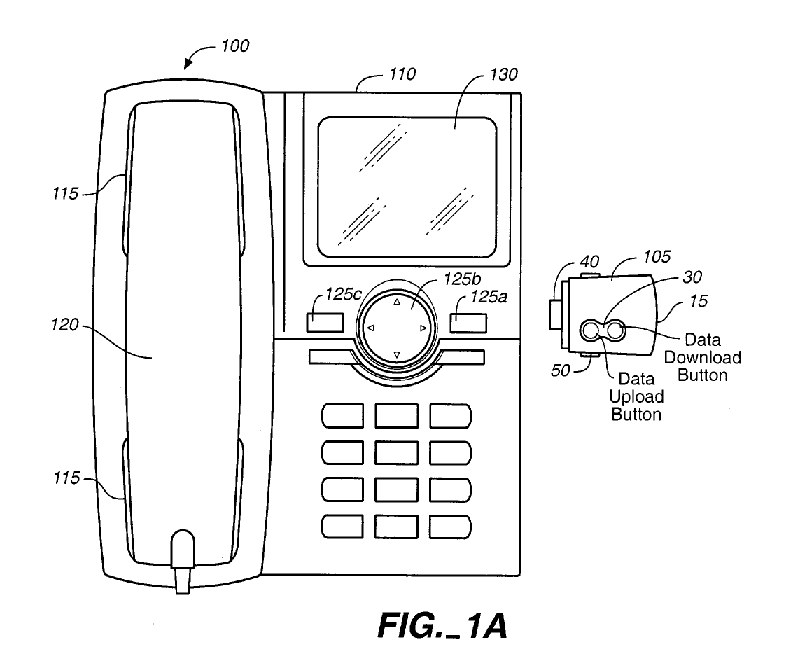

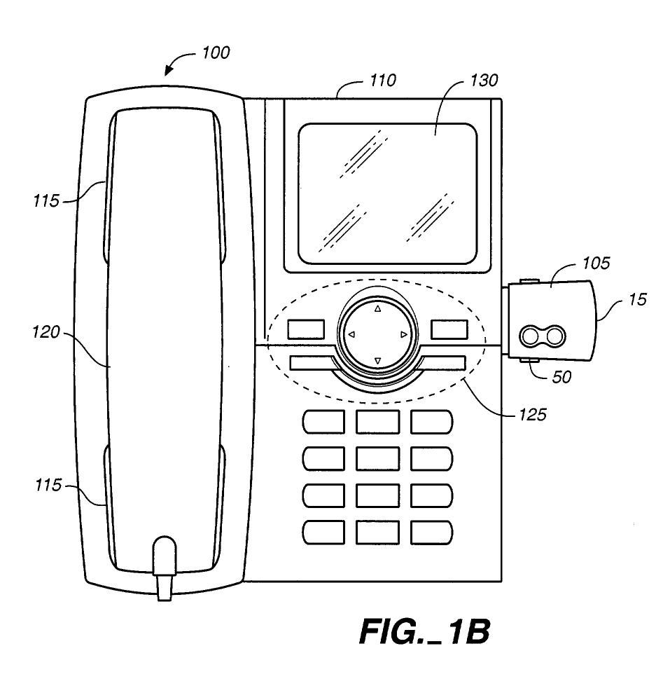

FIGS. 1A and 1B are front views of an exemplary desktop phone station 100 for synchronizing contact data with an external device, constructed according to an embodiment of the present invention. A first set of contact data is stored in a memory within desktop phone station 100. This desktop phone contact data generally includes a list of items with fields such as phone numbers and associated names. Other types of information can be stored as fields in the contact data items, such as mailing addresses, email addresses, and user IDs.

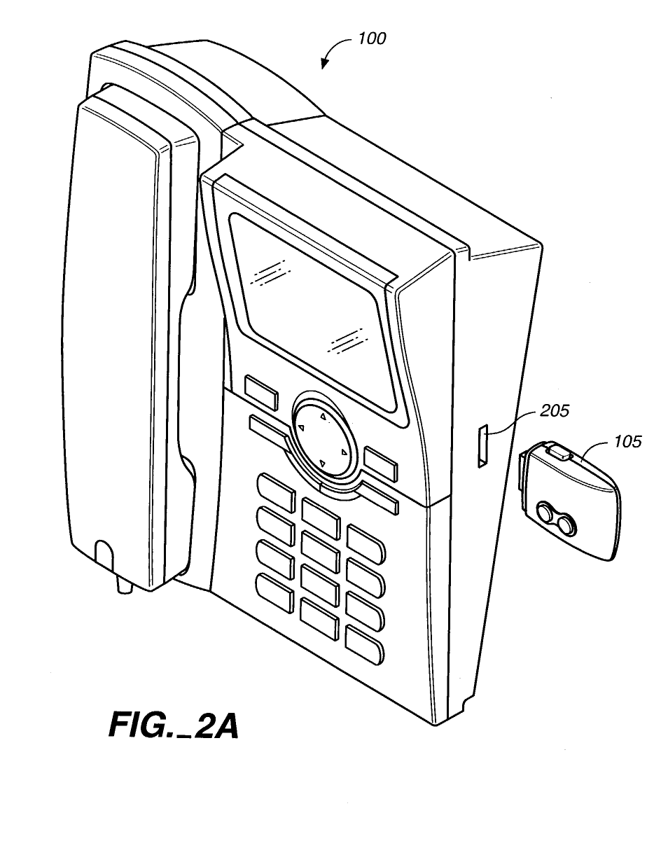

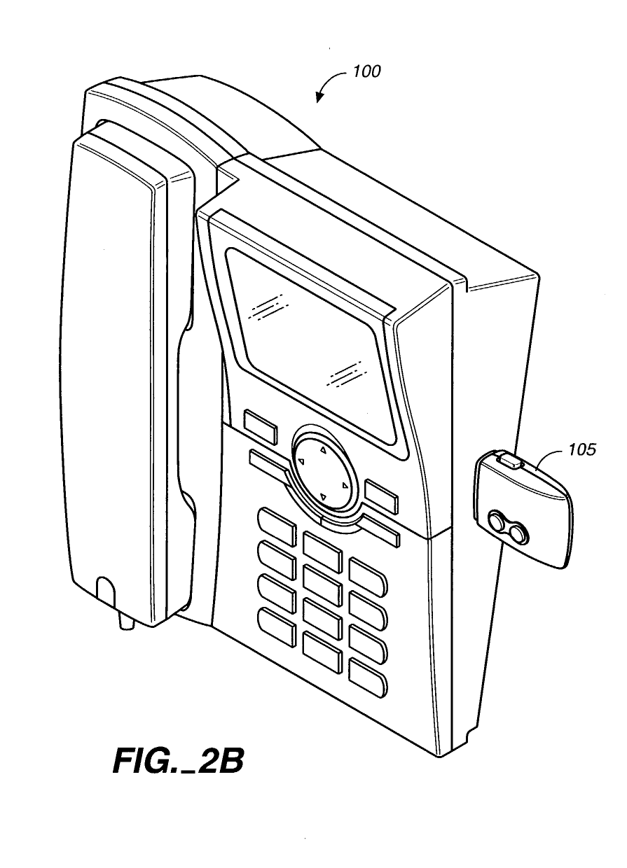

In FIGS. 1A and 1B, a second set of data is stored in an external device, such as a portable data loading device 105. This portable contact data similarly includes a plurality of contact data items or entries with phone numbers, associated names and, in some instances, additional information. Portable data loading device 105 is described in a U.S. patent application titled “Data Loading Device for Mobile Phones,” filed herewith on behalf of Inventor Hyon S. Bae, application Ser. No. ______, hereby incorporated by reference in its entirety. The portable contact data in portable data loading device 105 often includes contact information downloaded from a mobile phone such as a cell phone. As shown in FIGS. 1A, 1B, 2A, and 2B, the portable data loading device 105 is inserted into, mates with, or otherwise interfaces with a communications port provided on a side of casing 110. The particular configuration and functionality of the portable data loading device and communications port are described below.

In many situations, when the portable contact data in portable data loading device 105 is more current than the desktop phone contact data within desktop phone station 100, it is desirable to update the desktop phone contact data to include the more recent information in the portable contact data. Such is often the case when a user has manually entered new phone numbers, addresses or other fields into contact items stored on the portable data loading device as portable contact data, but has not made the same updates to the desktop phone contact data. In other situations, the reverse is true. That is, it is desirable for the portable contact data to be updated to reflect the current state of the desktop phone contact data. Embodiments of the present invention provide for both types of synchronization.

In FIG. 1A, desktop phone station 100 includes a casing 110 having an interior region and an exterior region. A handset docking area 115 is formed on the exterior region of casing 110. This handset docking area is common in many conventional desktop phones. The casing 110 is made of any suitable material, preferably a rugged material such as plastic, wood or metal. A handset 120 rests on the handset docking area 115. This handset 120 is similar to conventional handsets and connected to a handset communications interface in the casing 110 by conventional wired or wireless means. As with conventional handsets, a user lifts the handset 120 off of the handset docking area 115 to talk on the phone, and can rest the handset 120 on handset docking area 115 when handset 120 is not in use.

In FIG. 1A, a user interface 125 is mounted on the exterior region of casing 110. Various embodiments of user interface 125 are contemplated. In one embodiment, the user interface 125 includes a plurality of control buttons such as buttons 125a-c shown in FIG. 1. In this embodiment, the control buttons 125 are shaped and oriented similar to the layout of corresponding control buttons on some commercially available mobile phone models. These include control buttons such as cursor keys and scroll keys. In addition, one of control buttons 125a-c serves as a data synchronization button, the function of which is described below. In another embodiment, only one control button is provided on user interface 125, namely the data synchronization button. In FIG. 1A, a display 130 is also mounted on the exterior region of casing 110. The display 130 is, in one embodiment, an integral part of user interface 125, while in another embodiment, is remotely located and separate from user interface 125. In some embodiments, the display is a liquid crystal display. This display 130 is capable of displaying text and, in some embodiments, images. Often, text shown on display 130 includes prompt messages, and lists of contacts including names and phone numbers of the desktop phone contact data and portable contact data.

FIGS. 2A and 2B show perspective views of desktop phone station 100 in use with portable data loading device 105, according to an embodiment of the present invention. A communications port 205 is provided on a side of casing 110. This communications port 205 provides a communications interface for the portable data loading device 105. Thus, when portable data loading device 105 interfaces with communications port 205, portable contact data carried by data loading device 105 can be passed to desktop phone station 100 through the communications interface. FIGS. 2A and 2B show the progression of movement of portable data loading device 105 as the device moves from a position spaced apart from the communications port 205, in FIG. 2A, to a docked or mating position shown in FIG. 2B, in which portable loading device 105 interfaces with the communications port 205.

In FIGS. 2A and 2B, the communications port can have various shapes, sizes and configurations. In one embodiment, the communications port 205 has a female shape which mates with a male-shaped port 40 of portable data loading device 105. In another embodiment, the female and male shapes of the two ports are reversed. Other embodiments of communications port 205 include serial ports, parallel ports, and universal serial bus ports.

When the portable data loading device 105 is connected or otherwise in communication with desktop phone station 100 through communications port 205, data transfer between the desktop phone station 100 and portable data loading device 105 can begin. In one embodiment, when a user presses the data synchronization button on desktop phone 100, a data request signal is passed to portable data loading device 105 over communications port 205 requesting the portable contact data stored in loading device 105. Responsive to this request signal, portable data loading device 105 outputs the data to the communications port. This portable contact data is then synchronized with desktop phone contact data already stored in memory within the desktop phone station 100. In an alternative embodiment, data transfer from portable data loading device 105 to desktop phone station 100 is controlled by a selection mechanism on portable data loading device 105. The selection mechanism, when engaged as described below, can output data to the communications port 205. This data is then automatically stored in a buffer or cache memory within desktop phone station 100 or processed as the data is received. The user can control synchronization of this received portable contact data by viewing the portable contact data on the display 130 and deciding whether he wishes to synchronize this received data with the desktop phone contact data. If so, the user can press the data synchronization button on desktop phone station 100 to carry out the synchronization. This controlled synchronization can be carried out on an item-per-item basis, in which the user is prompted on the display whether he wishes to update particular contact items. In another embodiment, the entire synchronization is performed automatically responsive to the portable data loading device interfacing with the communications port 205.

In another embodiment, as described below, the portable data loading device 105 is capable of receiving data over communications port 205 from desktop phone station 100. In this embodiment, portable data loading device 105 sends a data request signal to desktop phone station 100 through communications port 205, requesting transfer of the desktop phone contact data. The synchronization processes described above can then be performed on the portable contact data instead of the desktop phone contact data, within desktop phone station 100 or within portable data loading device 105.

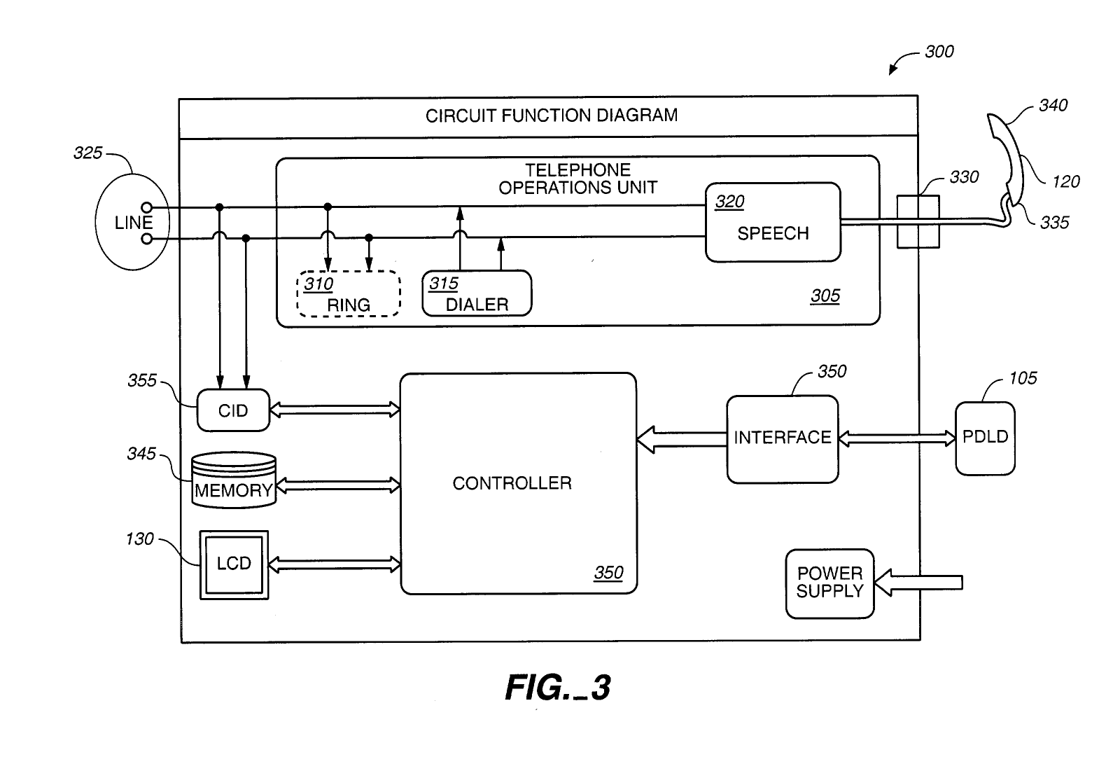

FIG. 3 shows a functional block diagram 300 of desktop phone station 100. Those skilled in the art should understand that various combinations of software and hardware can be used to implement the functional blocks shown in FIG. 3.

In FIG. 3, the desktop phone station 100 includes a telephone operations unit 305 which provides the features and functions of a conventional desktop phone. These include a ring module 310 which controls the phone ringing, a dialer module 315 which interacts with a numeric keypad provided on the exterior region of casing 110 to perform telephone dialing operations, and a speech module 320 which interacts with handset 120 to send and receive audio signals over the telephone line 325. The handset 120 includes a microphone 335 and a speaker 340 in communication with the handset communications interface 330 by conventional wired or wireless means. The handset communications interface 330 is mounted to the casing 110. The handset communications interface 330 is coupled to speech module 320 of telephone operations unit 305 as shown in FIG. 3.

In FIG. 3, a memory 345 is provided within casing 110. The memory 345 is any memory device suitable for storing contact data and other information. The memory 345 is coupled to a controller 350 which, in turn, interacts with other various units and modules in the desktop phone station 100, as shown in FIG. 3. The modules in communication with controller 350 include memory 345, the user interface 125 of FIG. 1, the interface 350 of the communications port 205, as well as caller ID module 355, display 130, and telephone operations unit 305. The controller interacts with the portable data loading device 105 through communications interface 350 to synchronize portable contact data received from communications port 205 with desktop phone contact data stored in memory 345.

Generally, the contact data synchronization process includes receiving the portable contact data over the communications interface 350, comparing items or fields in the portable contact data with the names and phone numbers already stored as desktop phone contact data in memory 345, identifying portable contact data items or fields not already included in the desktop phone contact data, then storing the identified portable contact data as part of the desktop phone contact data in memory.

In one example, a portable contact data item includes a name and phone number: “Jenny Smith, 867-5309.” There is no “Jenny Smith” entry in the desktop phone contact data, so the entire Jenny Smith item is stored as part of the desktop phone data. Sometimes certain information within a particular item has changed. For instance, the desktop phone contact data includes the entry, “Jenny Smith, 123-4567.” Jenny's phone number has since changed to 867-5309, as indicated in the portable contact data. Other information relating to the Jenny Smith contact (e.g., address, email) remains the same. When the comparison is performed between the desktop phone contact data and the portable contact data, the controller 350 identifies the discrepancy between the phone number fields in the respective Jenny Smith contact items. The controller 350 can address this difference in various ways. In one embodiment, the phone number in the portable contact data is automatically treated as the most current number for that particular contact, and recorded over the old phone number in the memory of the desktop phone station 100. In another embodiment, a message appears on display 130, requesting the user to choose which field to be stored as part of the Jenny Smith contact item in memory. In still another embodiment, both the fields are stored as phone numbers in the contact item. For instance, the 123-4567 and 867-5309 numbers can be stored as alternative phone numbers for Jenny Smith in memory 345. Preferably, the controller causes a prompt message to appear on display 130 so the user can choose whether to store both field entries, overwrite one field with the other, or disregard one of the field entries. Those skilled in the art should appreciate that embodiments of the present invention are capable of processing various fields in the contact data items, in addition to phone numbers, using the techniques described above.

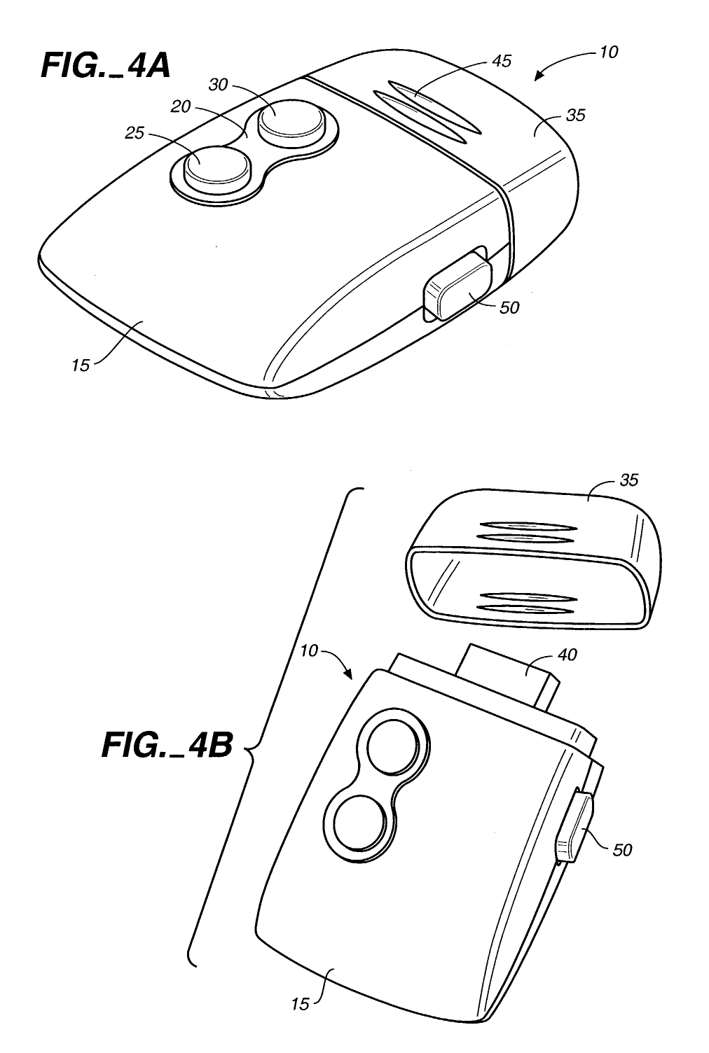

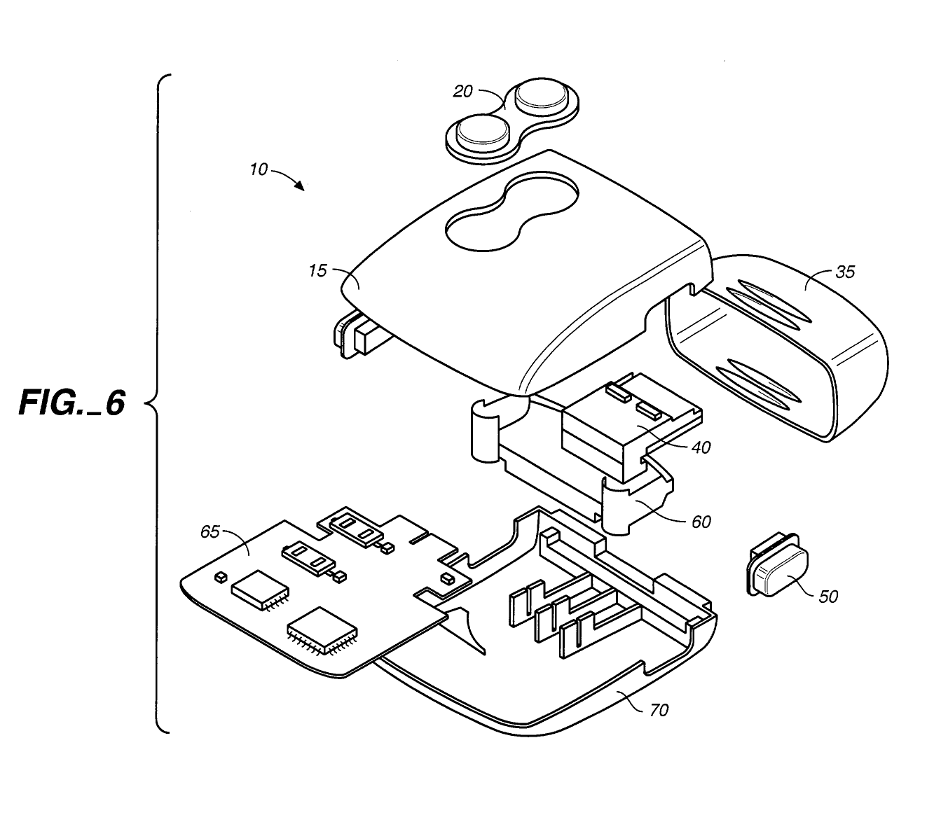

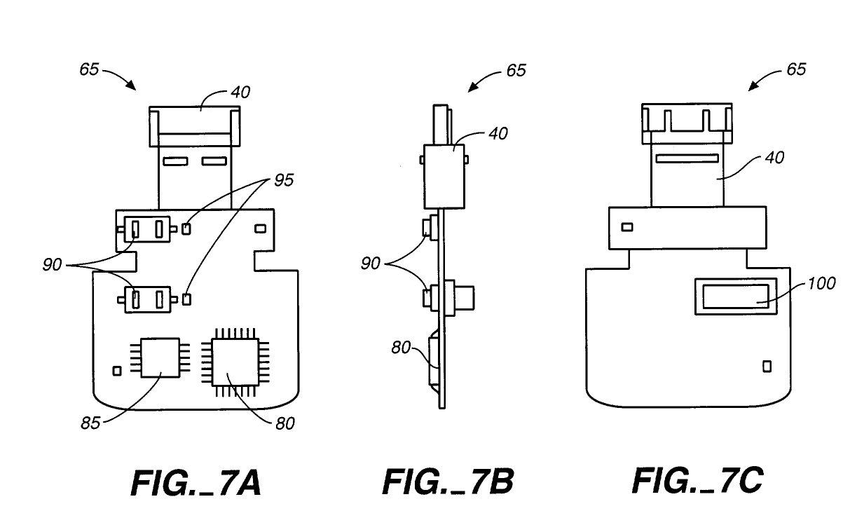

In FIG. 4A, an embodiment of the portable data loading device 10 is shown. The portable data loading device 10 has a housing 15 that contains the components and electrical circuitry described in FIGS. 6 and 7A-C below. The housing 15 may be a variety of materials, including, for example, injection-molded plastic, metal, metal alloys or other materials.

In FIG. 4A, the portable data loading device 10 also has selection mechanism 20 that, in this embodiment, is in the form of a pair of buttons, a first button 25 and a second button 30. The selection mechanism 20 serves to select between one of two functions achieved by the portable data loading device 10: the function of transferring data to a mobile phone, desktop phone station, or other external device connected to the portable data loading device 10 or the function of transferring data from the external device to the portable data loading device 10.

In FIGS. 4A and 4B, the first 25 and second 30 buttons thereby serve a convenient and simple function of allowing a user to depress either button depending on the function desired. Thus, if a user wishes to transfer data from the portable data loading device to a mobile phone, the user would press one of the buttons to transfer data off the portable data loading device. Should the user wish to transfer data to the portable data loading device 10 from a mobile phone or desktop phone station, then the user would depress the other button.

In FIGS. 4A and 4B, it is noted that this embodiment uses two buttons to achieve the functions of loading on or off data from the portable data loading device. Other embodiments use other selection mechanisms to achieve these above-described functions. For example, a single button may be used on the portable data loading device 10 that can differentiate between the transfer of data to the external device from the transfer of data from the external device by distinguishing between different sequences applied to the single button. For example, a first sequence may be based on the amount of time that the user holds down the single button. Thus, the portable data loading device 10 may have a single button (i.e. selection mechanism in this embodiment) that may be depressed for an amount of time that is distinguishable (e.g. by length of time that the button is depressed) from an amount of time of depressing the single button during a second sequence. Similarly, the first sequence for the single button may be distinguished from the second sequence based on the number of times that the single button is depressed. For example, a single depression of the single button, in one embodiment, may cause the data to be transferred from the portable data loading device 10 to the mobile phone. Then a double depression of the single button may cause the data to be transferred from the mobile phone to the portable data loading device 10. It is noted that the data transferred between the portable data loading device and the mobile phone may be any type of data stored typically stored on a mobile phone, desktop phone, or portable digital devices. In one embodiment, the data includes user-defined information such as names, addresses, and phone numbers. The data may also include mobile phone information such as the mobile phone serial number and custom settings for the phone (e.g., ringers, games, screen savers or wallpapers).

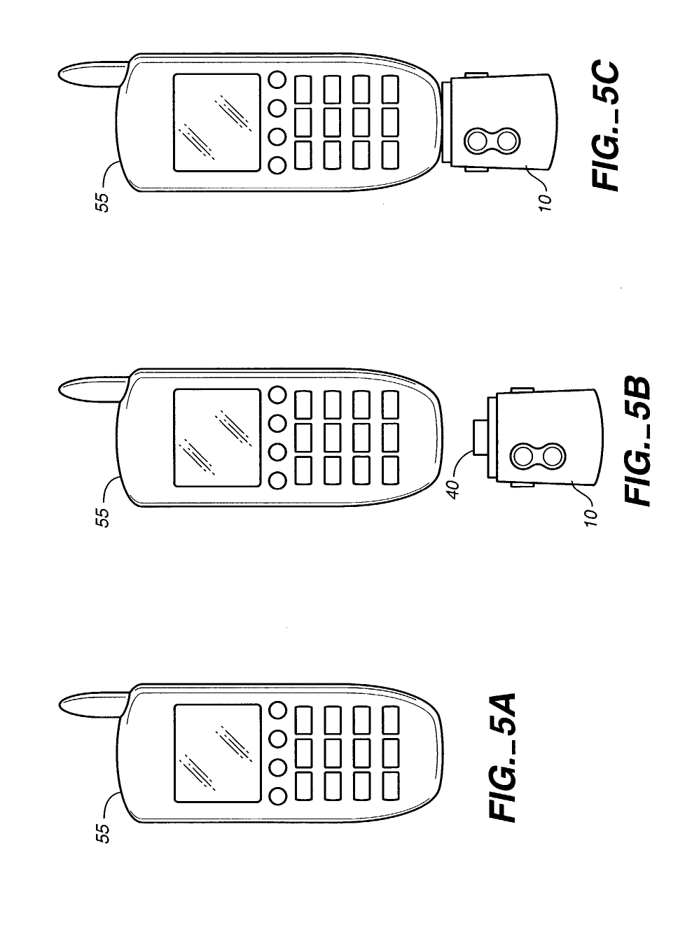

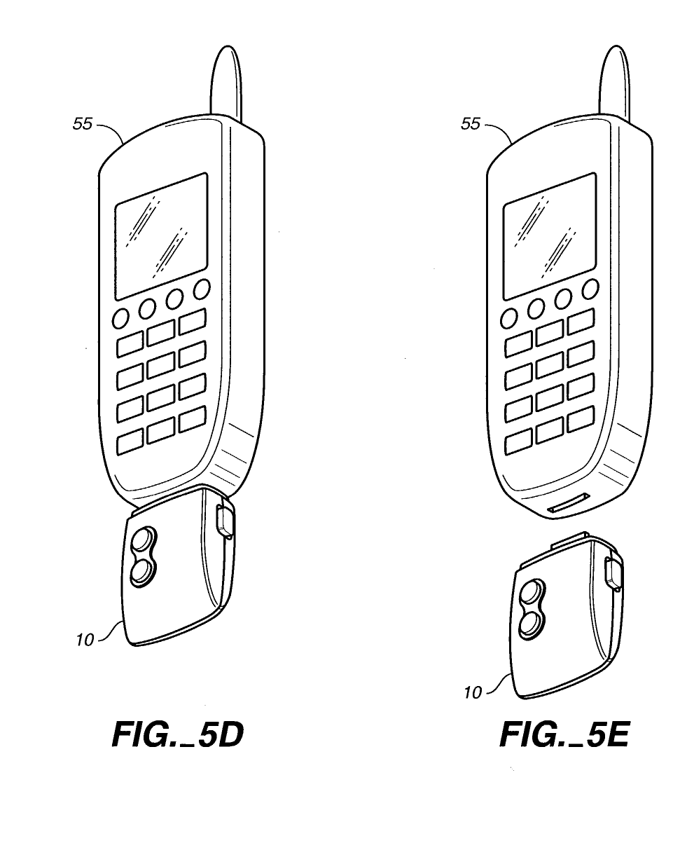

Returning to FIG. 4A, it is noted that the size of the portable data loading device 10 is preferably small. In one embodiment, the dimensions of the portable data loading device are 20 mm×30 mm×15 mm. This compact size of the device 10 allows the device 10 to be highly advantageous over a computer or similar product that may be capable, after complicated processes, of storing similar types of data from a phone. Any such computer would not have the portability of the device 10 that is achievable due to its small dimensions. These dimensions make it simple to carry the device 10 in a user's pocket or any carrying pouch or purse. The selection mechanism 20 further makes the device 10 very simple to use. Either by pushing one of two buttons, in one embodiment, or a single button, in alternative embodiments, the user may easily transfer data between a mobile phone and the device 10. It is this single step type of use that makes the device 10 simple to use. In an even further embodiment, no button needs to be used, since the selection mechanism may be incorporated directly into an input/output port (see FIG. 4B) to automatically initiate transferring data either to or from a mobile phone upon porting the device 10 on a mobile phone. In this embodiment, the act of placing the input/output port (FIG. 4B) in connection with a second port on the mobile phone, desktop phone station, or other device, will automatically trigger the transfer of information from the data loading device to the desktop phone station or vice versa. Again, any selection mechanism may be utilized to simply transfer data between the device 10 and the mobile phone. Due to the small size of the device, users may also be able to routinely carry the device 10 with them at all times in order to exchange data with other through the device 10. Thus, for example, a user may provide his or her contact information to another by simply placing the device 10 on another's mobile phone (as shown in FIGS. 5A-5E below) and transferring data to the mobile phone using a selection mechanism. In this way, there is no need to carry business cards or other identifying information since the device 10 may transfer such information simply and conveniently.

Returning to FIG. 4A, the device 10 has a port cover 35 that is used to protect the input/output port 40 of FIG. 4B. The protection is used to keep environmental contaminants such as dust or debris from damaging the port 40 and also to allow for convenient enclosure of the device 10 when not in use. The port cover 35 may be made from similar materials as the housing 15. The port cover 35 is secured by grooves 45 that expand and contract around the housing 15 to secure the port cover 35 to the housing 15. It is understood that other securing mechanisms may be used to secure the port cover 35 such as clasps and the like. A release button 50 on the device 10 allows the port cover 35 to be released by depressing the release button 50.

In FIG. 4B, the port cover 35 has been released from the housing 15 by depressing the release button 50. The input/output port 40 is exposed by removing the port cover 35. The port 40 may be any known input/output connector. For example, the port 40 may be a serial port, a parallel port, a universal serial bus. In further embodiments, the port 40 may include a cable that couples the device 10 to a mobile phone or desktop phone station rather than a port that is in direct connection to the mobile phone.

FIGS. 5A-5E are front views of an embodiment of the portable data loading device of the present invention in use with a mobile phone. In use, the device 10 (without the port cover 35) is connected to the mobile phone 55 by engaging the port 40 to a port on the mobile phone 55. Once the device 10 is connected directly to the mobile phone 55, the selection mechanism 20 may be engaged (e.g. by depressing first 25 and second 30 buttons in one embodiment) to transfer data to and from the mobile phone. It is understood that the device 10 need not only be connected to a mobile phone, but may also be connected to a second data loading device such as a personal digital assistant, a computer or a desktop phone. Again, all the advantages of the size, portability and simplicity of use are achieved even in use with the second data loading devices.

FIG. 6 is a perspective view of a disassembled embodiment of the portable data loading device of the present invention. In FIG. 6, the selection mechanism 20 is shown apart from the housing 15 and the port cover 35. The port 40 is shown above a latch spring 60. The latch spring 60 is used to provide a resilient connection between the port 40 and the port of the mobile phone or a second data loading device. Also shown in FIG. 6 is an assembled printed circuit board (PCB) 65 that is a board that contains the electrical components for transferring data to and from the device 10. Then the housing bottom 70 and the release button 50 are shown.

FIGS. 7A-7C are top, side and bottom views of an embodiment of the board of the portable data loading device of the present invention. In FIG. 7A, the top of the board 65 is shown. The board 65 of the device 10 is located in the housing 15. The board 65 has a data storage device 85 that contains the data that is transferred to and from the mobile phone. In one embodiment, the data storage device is a non-volatile memory device such as a flash memory device. In other embodiments, the data storage device may be any device that stores and retrieves data. In one embodiment, the storage device is a flash memory device manufactured by ATMEI with Model No. AT45DB02113. Also on the board 65 is a microcontroller 80 that controls the transfer of data to and from the data storage device 85 and a mobile phone. The microcontroller may be any conventional microcontroller or microprocessor. For example, the microcontroller 80 may be manufactured by ATMEI with Model No. ATMEGA6L. The board 65 further has tact switches 90 and light emitting diodes 95. FIG. 7B is a side view of the board 65 showing the similar structures of FIG. 7A. FIG. 7C likewise provides a bottom view of the board 65 and shows a crystal 100 used to operate the microcontroller 80.

Another desktop phone station constructed in accordance with an embodiment of the present invention has a communications port shaped and configured to mate directly with the port 55 of the mobile phone. In this embodiment, the communications port is preferably shaped as a docking port or pocket into which the mobile phone can be inserted. When inserted, the desktop phone communications port meets and interfaces with the mobile phone port 55. Thus, contact data can be downloaded directly from the mobile phone into memory in the desktop phone station for synchronization, and vice versa. In another embodiment, modular docking pockets shaped to receive various mobile phone models are provided with the desktop phone station. The user can select which docking pocket to mount in the desktop phone station to receive a particular mobile phone model.

Yet another desktop phone station constructed in accordance with an embodiment of the present invention provides for a cable to connect the mobile phone port 55 and the communications port of the desktop phone station. In one embodiment, the cable is a serial cable. Data can be passed through the cable between the mobile phone and the desktop phone station for synchronization using techniques described above.

It should be emphasized that the above-described embodiments of the invention provide examples for a clear understanding of the principles of the invention. Variations and modifications can be made to the above-described embodiments without departing from the spirit and principles of the invention, as will be understood to those skilled in the art. All such modifications and variations are intended to be included within the scope of the invention and protected by the following claims.

What is claimed is:

1. A desktop phone station for synchronizing desktop phone contact data with portable contact data stored in a portable data loading device, the desktop phone station comprising:
a casing having an interior region and an exterior region, a handset docking area formed on the exterior region of the casing;
a telephone operations unit situated in the casing interior region, the telephone operations unit including a ring module, a dialer module, and a speech module coupled to a telephone line interface mounted to the casing and accessible from the casing exterior region;
a handset communications interface mounted to the casing and accessible from the casing exterior region, the handset communications interface coupled to the speech module of the telephone operations unit;
a handset having a microphone and a speaker in communication with the handset communications interface, the handset capable of being rested on the handset docking area when not in use;
a user interface provided on the exterior region of the casing, the user interface including a plurality of control buttons, one of the control buttons being a data synchronization button, and a display mounted on the exterior region of the casing, the display capable of displaying information including the desktop phone contact data;
a memory provided in the interior region of the casing, the memory storing the desktop phone contact data;
a communications port providing a communications interface for the portable data loading device such that the communications port is capable of receiving the portable contact data from the portable data loading device;
a controller coupled to the memory and the communications interface, the controller interacting with the memory and the communications interface to synchronize the portable contact data received from the communications port with the desktop phone contact data stored in the memory responsive to the data synchronization button being pressed.

2. The desktop phone station of claim 1, the controller synchronizing the portable contact data with the desktop phone contact data by:
i) receiving a plurality of portable contact data items over the communications interface,
ii) comparing the portable contact data items with a plurality of desktop phone contact data items stored in the memory, and
iii) identifying at least one of the portable contact data items not included in the desktop phone contact data items,
iv) storing the identified at least one portable contact data item in the memory as one of the desktop phone contact data items.

3. The desktop phone station of claim 2, the desktop phone contact data and the portable contact data including a list of phone numbers and names of individuals associated with the respective phone numbers.

4. The desktop phone station of claim 1, the controller synchronizing the portable contact data with the desktop phone contact data by:
i) receiving a portable contact data item having a field over the communications interface,
ii) comparing the field of the received portable contact data item with a field of a corresponding desktop phone contact data item stored in the memory, and
iii) determining whether the fields of the corresponding portable contact data item and desktop phone contact data item have different information, and
iv) storing, when the fields of the portable contact data item and desktop phone contact data item have different information, the field of the portable contact data item as the field of the corresponding desktop phone contact data item in the memory.

5. The desktop phone station of claim 4, the fields being phone numbers.

6. The desktop phone station of claim 1, the controller synchronizing the portable contact data with the desktop phone contact data by:
i) receiving a plurality of portable contact data items over the telephone line interface, and
ii) storing the received portable contact data items in the memory as the desktop phone contact data items.

7. The desktop phone station of claim 1, the display showing a prompt message requesting the user to press the data synchronization button responsive to the communications port interfacing with the portable data loading device.

8. The desktop phone station of claim 1, the communications port having a female shape.

9. The desktop phone station of claim 1, the communications port being a serial port.

10. The desktop phone station of claim 1, the communications port being a parallel port.

11. The desktop phone station of claim 1, the communications port being a universal serial bus port.

12. The desktop phone station of claim 1, the display being a liquid crystal display.

13. The desktop phone station of claim 1, the control buttons of the user interface including a cursor key.

14. The desktop phone station of claim 1, the control buttons of the user interface including a scroll key.

15. A desktop phone system for synchronizing desktop phone contact data with portable contact data, the desktop phone system comprising:
a portable data loading device including:
a housing,
a board within the housing, the board including:
a data storage device storing the portable contact data, and
a microcontroller controlling the transfer of data to and from the mobile phone,
an input/output port in communication with the board; and
a desktop phone station including:
a casing having an interior region and an exterior region, a handset docking area formed on the exterior region of the casing,
a telephone operations unit situated in the casing interior region, the telephone operations unit including a ring module, a dialer module, and a speech module coupled to a telephone line interface mounted to the casing and accessible from the casing exterior region,
a handset communications interface mounted to the casing and accessible from the casing exterior region, the handset communications interface coupled to the speech module of the telephone operations unit,
a handset having a microphone and a speaker in communication with the handset communications interface, the handset capable of being rested on the handset docking area when not in use,
a user interface provided on the exterior region of the casing, the user interface including a plurality of control buttons, one of the control buttons being a data synchronization button, and a display mounted on the exterior region of the casing, the display capable of displaying information including the desktop phone contact data,
a memory provided in the interior region of the casing, the memory storing the desktop phone contact data,
a communications port providing a communications interface for the input/output port of the portable data loading device such that the communications port is capable of receiving the portable contact data from the portable data loading device, and
a controller coupled to the memory and the communications interface, the controller interacting with the memory and the communications interface to synchronize the portable contact data received from the communications port with the desktop phone contact data stored in the memory responsive to a data synchronization operation being initiated.

16. The desktop phone system of claim 15, the portable data loading device further comprising a selection mechanism in communication with the board enabling selection between the transfer of data from the portable data loading device or the transfer of data to the portable data loading device.

17. The desktop phone system of claim 15, the controller synchronizing the portable contact data with the desktop phone contact data by:
i) receiving a plurality of portable contact data items over the communications interface,
ii) comparing the portable contact data items with a plurality of desktop phone contact data items stored in the memory, and
iii) identifying at least one of the portable contact data items not included in the desktop phone contact data items,
iv) storing the identified at least one portable contact data item in the memory as one of the desktop phone contact data items.

18. The desktop phone system of claim 15, the controller synchronizing the portable contact data with the desktop phone contact data by:
i) receiving a portable contact data item having a field over the communications interface,
ii) comparing the field of the received portable contact data item with a field of a corresponding desktop phone contact data item stored in the memory, and
iii) determining whether the fields of the corresponding portable contact data item and desktop phone contact data item have different information, and
iv) storing, when the fields of the portable contact data item and desktop phone contact data item have different information, the field of the portable contact data item as the field of the corresponding desktop phone contact data item in the memory.

19. The desktop phone system of claim 15, the controller synchronizing the portable contact data with the desktop phone contact data by:
i) receiving a plurality of portable contact data items over the telephone line interface, and
ii) storing the received portable contact data items in the memory as the desktop phone contact data items.

20. The desktop phone system of claim 15, the display showing a prompt message requesting the user to press a data synchronization button to initiate the data synchronization operation responsive to the communications port interfacing with the portable data loading device.

21. A desktop phone system for synchronizing desktop phone contact data with portable contact data, the desktop phone system comprising:
a portable data loading device including:
a housing,
a board within the housing, the board including:
a data storage device storing the portable contact data, and
a microcontroller controlling the transfer of data to and from the mobile phone,
a selection mechanism in communication with the board enabling selection between the transfer of data from the portable data loading device or the transfer of data to the portable data loading device, the selection mechanism initiating the transfer of data when activated, and
an input/output port in communication with the board; and
a desktop phone station including:
a casing having an interior region and an exterior region, a handset docking area formed on the exterior region of the casing,
a telephone operations unit situated in the casing interior region, the telephone operations unit including a ring module, a dialer module, and a speech module coupled to a telephone line interface mounted to the casing and accessible from the casing exterior region,
a handset communications interface mounted to the casing and accessible from the casing exterior region, the handset communications interface coupled to the speech module of the telephone operations unit,
a handset having a microphone and a speaker in communication with the handset communications interface, the handset capable of being rested on the handset docking area when not in use,
a user interface provided on the exterior region of the casing, the user interface including a plurality of control buttons, and a display mounted on the exterior region of the casing, the display capable of displaying information including the desktop phone contact data,
a memory provided in the interior region of the casing, the memory storing the desktop phone contact data,
a communications port providing a communications interface for the portable data loading device such that the communications port receives the portable contact data from the portable data loading device when the transfer of data from the portable data loading device is selected and the selection mechanism activated, and
a controller coupled to the memory and the communications interface, the controller interacting with the memory and the communications interface to synchronize the portable contact data received from the communications port with the desktop phone contact data stored in the memory.

22. The desktop phone system of claim 21, one of the control buttons of the user interface being a data synchronization button, the controller synchronizing the portable contact data with the desktop phone contact data responsive to the data synchronization button being pressed.

23. The desktop phone system of claim 21 wherein the selection mechanism of the portable data loading device includes:
a first button, the first button being depressed to transfer data from the portable data loading device, and
a second button, the second button being depressed to transfer data to the portable data loading device.

24. The desktop phone system of claim 21 wherein the selection mechanism includes a single button, the single button being depressed in a first sequence to transfer data from the portable data loading device and the single button being depressed in a second sequence to transfer data to the portable data loading device.

25. The desktop phone system of claim 24 wherein the first sequence further comprises depressing the single button for an amount of time that is distinguishable from an amount of time for depressing the single button for the second sequence.

26. The desktop phone system of claim 24 wherein the first sequence further comprises depressing the single button for a number of times that is distinguishable from a number of times for depressing the single button for the second sequence.
